(19) United States
(12) Patent Application Publication
(10) Pub. No.: US 2026/0009671 A1
(43) Pub. Date: Jan. 8, 2026

(54) SUPPORT FOR A WEIGHING DEVICE

(71) Applicant: METRYX LTD., Bristol (GB)

(72) Inventors: Gregor Robert ELLIOTT, Gloucester (GB); Sam OWENS, Caldicot (GB); Huw DUTTON, Bristol (GB); Prashant SAXENA, Stonehouse (GB)

(21) Appl. No.: 18/880,977

(22) PCT Filed: Jun. 20, 2023
(86) PCT No.: PCT/EP2023/066579

§ 371 Date: Jan. 3, 2025

(30) Foreign Application Priority Data
Jul. 7, 2022 (GB) 2209995.6

(51) Int. Cl. G01G 21/23; G01G 21/28

(52) U.S. Cl. CPC G01G 21/23; G01G 21/28

(57) ABSTRACT

A support for a weighing device, the support comprising: a support part for supporting an object during a weight measurement; and a mounting part for mounting the support on a weighing device; wherein the support part and the mounting part are electrically connected by a component having an electrical resistance greater than or equal to 100 kΩ and less than or equal to 10 MΩ.

### FIELD OF THE INVENTION

The present invention relates to a support for a weighing device, and to a weighing device having such a support.

### BACKGROUND OF THE INVENTION

Microelectronic devices are fabricated on semiconductor (e.g. silicon) wafers using a variety of techniques, e.g. including deposition techniques and removal techniques. Semiconductor wafers may be further treated in ways that alter their mass, e.g. by cleaning, ion implantation, lithography and the like.

Depending on the device being manufactured, each semiconductor wafer may be passed sequentially through hundreds of different processing steps to build up and/or to remove the layers and materials necessary for its ultimate operation. In effect, each semiconductor wafer is passed down a production line. The nature of semiconductor manufacturing means that certain processing steps or sequences of steps in the production flow may be repeated in a similar or identical fashion. For example, this may be to build up similar layers of metal conductors to interconnect different parts of the active circuitry.

The cost and complexity of the processing steps required to produce a completed silicon wafer together with the time that it takes to reach the end of the production line where its operation can be properly assessed has led to a desire to monitor the operation of the equipment on the production line and the quality of the wafers being processed throughout processing, so that confidence in the performance and yield of the final wafers may be assured.

Wafer treatment techniques typically cause a change in mass at or on the surface of the semiconductor wafer. The configuration of the changes to the surface are often vital to the functioning of the device, so it is desirable for quality control purposes to assess wafers during production in order to determine whether they have the correct configuration.

Specialist metrology tools may be used within the production flow so that monitoring is conducted soon after the relevant process of interest and usually before any subsequent processing, i.e. between processing steps.

Measuring the change in mass of a wafer either side of a processing step is an attractive method for implementing product wafer metrology. It is relatively low cost, high speed and can accommodate different wafer circuitry patterns automatically. In addition, it can often provide results of higher accuracy than alternative techniques. For example, on many typical materials, thicknesses of material layers can be resolved down to an atomic scale. The wafer in question is weighed before and after the processing step of interest. The change in mass is correlated to the performance of the production equipment and/or the desired properties of the wafer.

On a wafer, electric charges can exist on its surface (surface charge) or within its body (substrate, embedded charge). Electric charges can be caused by a variety of means, e.g. earlier processing or fabrication steps, tribology, contact electrification, etc.

When a charged wafer is present on a weighing pan of a weighing device, and the charge on the wafer is not discharged, the charge may lead to an electrostatic force between the wafer and the surroundings. For example, there may be an electrostatic force between the wafer and a load cell of the weighing device, or between the wafer and a measurement enclosure of the weighing device.

This electrostatic force may cause the weight force measured by the load cell to be erroneously high or low, depending on the direction of the electrostatic force, leading to an error in the weight measurement.

It is therefore advantageous to allow a charged wafer present on the weighing pan of the weighing device to discharge before performing a weight measurement, for example through the weighing device, to prevent such electrostatic forces from causing errors in the weight measurement.

For example, this may be achieved by making all components of the weighing pan from conductive materials such as metal, so that any electric charges on the wafer can freely discharge through the weighing pan to the load cell when the wafer is on the weighing pan.

However, if a discharge peak through a load cell of the weighing device is too high, this may cause errors in the measurement output of the load cell, and/or damage the load cell.

A load cell of a weighing device is typically grounded (electrically connected to ground). If a large electrostatic charge is present on a wafer (for example 100 s to 1000 s of volts of surface potential), this charge may discharge to ground through the weighing pan and the load cell when the wafer is loaded onto the weighing pan. This discharge may result in a discharge spike having a low current and high voltage that lasts for a very short period of time, for example a few nanoseconds. This transient spike in voltage may affect and/or damage sensitive electronic components in the load cell.

In addition, or alternatively, if the charge on a wafer is large enough, then as the distance between the wafer and the weighing pan is reduced as the wafer is lowered onto the weighing an arc event may occur, just before full contact between the wafer and the weighing pan occurs. Such an arc event can cause a very fast, short duration spike in voltage, which may affect and/or damage sensitive electronic components in the load cell.

A weighing pan 1 for a weighing device that has previously been used by the inventors and that allows at least partially controlled discharge of a charged wafer is illustrated schematically in FIG. 1.

As shown in FIG. 1, the weighing pan 1 comprises a pan part 3 for supporting a wafer during a weight measurement. The pan part 3 is configured to contact an underside of the wafer to support the wafer.

The pan part 3 comprises a plurality of pins 4 that protrude from a top surface of the pan part 3 perpendicular to a main plane of the pan part 3. The pins 4 are configured to contact an underside of the wafer so as to support the wafer. Typically, there are three of the pins 4, arranged in a triangular arrangement.

The weighing pan 1 further comprises a leg 5 that extends perpendicularly to the pan part 3. The leg 5 is configured to be received by a weighing device so as to mount the weighing pan 1 on the weighing device.

The leg 5 may be in the form of a cylinder, rod or pin. In some cases, the leg 5 may be tapered.

The weighing pan 1 further comprises an electrical and thermal insulator part 7 positioned between the pan part 3 and the leg 5. The pan part 3 and the leg 5 are physically separated by the electrical and thermal insulator part 7. Furthermore, the pan part 3 and the leg 5 are electrically and thermally insulated from each other by the electrical and thermal insulator part 7.

Typically, the electrical and thermal insulator part 7 is made of a ceramic.

The electrical and thermal insulator part 7 prevents heat from a wafer on the weighing pan 1 from being conducted to the load cell through the weighing pan 1, where it may cause an error in the output of the load cell.

However, as mentioned above, electrical charges trapped on a wafer on the weighing pan 1 can also cause inaccurate measurements by the load cell, due to electrostatic forces between the wafer and the surroundings.

Therefore, to enable discharge of electrical charge on the wafer through the weighing pan 1 to the load cell, the weighing pan 1 comprises a metal spring 9 that electrically connects the pan part 3 to the leg 5. The metal spring 9 is located inside the electrical and thermal insulator part 7 and extends across (i.e. spans) the electrical and thermal insulator part 7.

The spring 9 is an electrical conductor that allows discharge of electrical charge from the pan part 3 to the leg 5, where it can be discharged to the load cell. Therefore, electrical charge can be discharged from the wafer through the weighing pan 1.

Typically, the metal spring 9 is a helical spring.

The leg part 5 is made of an electrically conductive material, such as stainless steel, so that electrical charge can be conducted through the leg part 5 to the load cell.

To control discharge of the electrical charge from the wafer, the pins 4 are not fully conductive. In particular, at least a part of the pins 4 that contacts the wafer may be made of a semiconductor material. Such a semiconductor material may control discharge of charges from the wafer to the weighing pan 3.

In one example, the pins 4 may comprise a metal shaft having a silicon carbide ball at the top of the metal shaft, so that the silicon carbide ball is arranged to contact the underside of the wafer. Silicon carbide is a semiconductor, and its resistance is not uniform with voltage.

In a second example, the pins 4 may comprise conductive PEEK plastic arranged to contact the underside of the wafer. Conductive PEEK plastic is also a semiconductor, and its resistance is not uniform with voltage.

Other parts of the weighing pan 3 may be made electrically conductive. For example, other parts of the weighing pan 3 may be made of one or more conductive materials such as metal.

### SUMMARY OF THE INVENTION

The present inventors have realised that with the above-described arrangements, a sharp discharge spike of electric charge to the load cell from the weighing pan 1 can still occur in some circumstances. As mentioned above, a large discharge spike to the load cell can cause errors in the measurement output of the load cell.

Furthermore, the present inventors have realised that with the above-described arrangements the electric charge on the wafer may not be fully discharged in some cases, leading to errors in the measurement output as described above.

In particular, the present inventors have realised that the electrical resistance of the path from the wafer to ground will control the voltage and current characteristics of the discharge spike. Ideally, the charge on the wafer would be dissipated completely so the wafer reaches ground potential (V=0). However, the electrical resistance and breakdown characteristics of the materials used in the discharge path may result in residual charge being left on the wafer (V>0).

The variability in the discharge characteristics may result in varying amounts of residual charge on the wafer, which may introduce errors into the measurement output as described above.

The present invention may address one or more of these issues.

Although the above discussion has been in relation to weighing wafers, such as semiconductor wafers, the present invention is also applicable to weighing other objects.

At its most general, the present invention proposes providing an electrically resistive component having a predetermined resistance between two parts of a weighing support, to restrict and/or control the discharge of electric charge through the weighing support.

A peak of the electric discharge through the weighing support may therefore be controlled by controlling the predetermined resistance of the electrically resistive component. For example, if the predetermined resistance of the electrically resistive component is made higher, a peak of the electric discharge may be made lower. However, if the predetermined resistance of the electrically resistive component is too high, the electric charge of the object may not be effectively or efficiently discharged.

According to a first aspect of the present invention there is provided a support for a weighing device, the support comprising:

a support part for supporting an object during a weight measurement; and

a mounting part for mounting the support on a weighing device;

wherein the support part and the mounting part are electrically connected by a component having an electrical resistance greater than or equal to 100 kΩ and less than or equal to 10 MΩ.

An electrical resistance greater than or equal to 100 kΩ and less than or equal to 10 MΩ is sufficiently low to allow discharge of electric charge on the wafer through the weighing support, but sufficiently high to limit a peak of the electric discharge.

The support of the present invention may improve the measurement output variability of a weighing device by improving the consistency of discharge and residual voltage left on the object by controlling the resistance of the discharge path from the object to the weighing device and/or to ground.

The first aspect of the present invention may have any one, or, where compatible, any combination of the following optional features.

The support may be a pan. The term support may therefore be replaced with the term pan throughout, unless incompatible.

The pan may be a weighing pan or a balance pan.

The support part may be a pan part. The term support part may therefore be replaced with the term pan part throughout, unless incompatible.

The pan part may be a weighing pan part or a balance pan part.

The support may be a weighing support.

The support may be for supporting the object during the weight measurement.

The support may be for use in, or with, the weighing device.

The support may be referred to as a support arrangement or support assembly.

A weighing device may mean a device for performing a weight measurement on an object.

A weighing device may mean a device for generating measurement output indicative of the weight of an object.

A weighing device may mean a device for weighing an object, and/or measuring the weight of an object.

The support part may be for supporting the object during a weight measurement performed on the object by the weighing device.

The support part may be configured to support the object during a weight measurement.

The object may be a wafer, such as a semiconductor wafer.

The support part may therefore be configured to support a wafer during a weight measurement.

Supporting an object may mean supporting the weight of the object.

Supporting an object may mean holding or carrying the object.

The mounting part may be configured to be received by a weighing device to mount the support on the weighing device.

The mounting part may be a leg or pin or shaft, for example.

The mounting part may extend perpendicularly, or substantially perpendicularly, to the support part.

The mounting part may be tapered.

The mounting part may be a protrusion or protruding part.

The mounting part may be cylindrical, or substantially cylindrical.

When an object is loaded on the support part of the support, the weight force may be transmitted to the weighing device through the mounting part.

The mounting part may be located, or substantially located, on a central axis of the support.

The mounting part may extend along, or substantially along, a central axis of the support.

The mounting part may be a shaft, for example a central shaft or an axial shaft.

The mounting part may support the support part.

The support part may be mounted on the mounting part.

The mounting part is below the support part when the support is mounted on the weighing device.

Mounting the support on the weighing device may comprise the support being positioned or located on the weighing device, and/or the support being received by the weighing device (for example the mounting part being received by the weighing device).

The support is typically located on top of the weighing device, and/or above the weighing device.

The weighing device may comprise a load cell.

The load cell may be grounded (electrically connected to ground).

The weighing device may comprise a weight force transducer.

The weighing device may comprise or be an electronic balance.

The weighing device may comprise or be a microbalance.

The component may be a part, or an element.

The component may directly electrically connect the support part and the mounting part.

The component may contact both the support part and the mounting part.

The component electrically connecting the support part and the mounting part means that electricity can be conducted from the support part to the mounting part through or via the component.

The component electrically connecting the support part and the mounting part means electrically connecting the support part to the mounting part.

The component electrically connects the support part and the mounting part together or to each other.

The component may be an electrically resistive component.

The component may have an electrical resistance greater than or equal to 500 kΩ.

The component may have an electrical resistance less than or equal to 5 MΩ.

The component may have an electrical resistance less than or equal to 2 MΩ.

The component may have an electrical resistance less than or equal to 1.5 MΩ.

The component may have an electrical resistance greater than or equal to 500 kΩ and less than or equal to 2 MΩ.

The component may comprise a resistor or a resistor wire or a resistive film or a resistive element or a resistive structure, for example.

The resistor or the resistor wire or the resistive film or the resistive element or the resistive structure may have the specified electrical resistance.

The support part and the mounting part may be electrically isolated or separated from each other, other than via or through the electrical connection provided by the component.

There may be a single electrical path from the support part to the mounting part, wherein the single electrical path is via or through the component.

The component may provide the only electrical connection between the support part and the mounting part.

The support may further comprise an electrical insulator part between the support part and the mounting part.

The electrical insulator part may electrically isolate the support part from the mounting part, other than via or through the electrical connection provided by the component.

The component may be located inside the electrical insulator part.

The component may span the electrical insulator part.

The electrical insulator part may be positioned or located between the support part and the mounting part.

The support part may be physically separated from the mounting part by the electrical insulator part.

The electrical insulator part may contact both the support part and the mounting part.

The electrical insulator part may comprise, or be made of or substantially made of, one or more electrically insulating materials, such as a ceramic and/or a plastic.

The electrical insulating part may also be a thermal insulator. This is advantageous because heat can be prevented from being conducted from the object to the weighing device.

The support part may be electrically conductive or a conductor.

The support part may be configured to conduct electricity from an object supported by the support part to the component.

The whole (or substantially the whole) of the support part may be electrically conductive or a conductor.

The entire (or substantially the entire) support part may be electrically conductive or a conductor.

All (or substantially all) of the support part may be electrically conductive or a conductor.

The support part may be made of, or mainly made of, one or more electrically conductive materials or one or more conductors.

The whole (or substantially the whole) of the support part may be made of one or more electrically conductive materials or one or more conductors.

The entire (or substantially the entire) support part may be made of one or more electrically conductive materials or one or more conductors.

All (or substantially all) of the support part may be made of one or more electrically conductive materials or one or more conductors.

The support part may be made of, or mainly made of, one or more metals.

The whole (or substantially the whole) of the support part may be made of one or more metals.

The entire (or substantially the entire) support part may be made of one or more metals.

All (or substantially all) of the support part may be made of one or more metals.

The one or more metals may comprise or be aluminium or stainless steel, for example. Aluminium may be preferably due to its low weight.

The mounting part may be electrically conductive or a conductor.

The mounting part may be configured to conduct electricity from the component to a weighing device on which the support is mounted.

The whole (or substantially the whole) of the mounting part may be electrically conductive or a conductor.

The entire (or substantially the entire) mounting part may be electrically conductive or a conductor.

All (or substantially all) of the mounting part may be electrically conductive or a conductor.

The mounting part may be made of, or mainly made of, one or more electrically conductive materials.

The whole (or substantially the whole) of the mounting part may be made of one or more electrically conductive materials or one or more conductors.

The entire (or substantially the entire) mounting part may be made of one or more electrically conductive materials or one or more conductors.

All (or substantially all) of the mounting part may be made of one or more electrically conductive materials or one or more conductors.

The mounting part may be made of, or mainly made of, one or more metals.

The whole (or substantially the whole) of the mounting part may be made of one or more metals.

The entire (or substantially the entire) mounting part may be made of one or more metals.

All (or substantially all) of the mounting part may be made of one or more metals.

The one or more metals may comprise or be aluminium or stainless steel, for example. Aluminium may be preferably due to its low weight.

The support part may comprise a plurality of contact elements that are configured to support the object during the weight measurement.

The plurality of contact elements may extend or protrude from a top surface of the support part.

The contact elements may comprise or be pins.

The contact elements may comprise or be contact parts or contact members, for example.

The contact elements may be electrically conductive or conductors.

The contact elements may be made of one or more electrically conductive materials.

The contact elements may be made of one or more metals.

The contact elements may be made of stainless steel or aluminium, for example. Stainless steel may be preferred due to its durability and/or its lower thermal conductivity.

The contact elements may be configured to contact an underside of the wafer to support a wafer.

There may be three of the contact elements.

There may be three or more of the contact elements.

The contact elements may be arranged in a triangle.

At least part of one or more of the contact elements may be coated, for example with an electrically conductive coating.

The coating may be titanium nitride, for example.

At least the distal ends of the contact elements may be coated, for example.

The support may be configured to provide an electrical path between an object supported by the support part and a weighing device on which the support is mounted by the mounting part, wherein the electrical path is via or through the component.

The electrical path may comprise all electrically conductive materials and/or electrical conductors apart from the component.

The support may be configured to provide only a single electrical path between the object supported by the support part and the weighing device on which the support is mounted by the mounting part, wherein the single electrical path is via or through the component.

The electrical path may comprise all electrically conductive materials and/or electrical conductors apart from the component.

The electrical path may be a discharge path, or a static discharge path.

According to a second aspect of the present invention there is provided a weighing device having the support according to the first aspect of the present invention.

The second aspect of the present invention may have any of the features of the first aspect of the present invention, unless incompatible with the features of the second aspect of the present invention.

For example, the weighing device may have any of the features of the weighing device mentioned above.

The support may have any of the features of the support mentioned above.

The support may be mounted on the weighing device.

The support may be received by the weighing device. For example, the mounting part of the support may be received by the weighing device.

The weighing device may comprise a load cell.

The load cell may be grounded (electrically connected to ground).

The weighing device may comprise a weight force transducer.

The load cell or weight force transducer may be configured to measure a weight of an object loaded on the support.

The weighing device may further comprise a measurement chamber.

The weighing device may be located inside a measurement chamber.

The support may be configured to provide an electrical path between an object supported by the support part and the weighing device, wherein the electrical path is via or through the component.

The support may be configured to provide only a single electrical path between the object supported by the support part and the weighing device, wherein the single electrical path is via or through the component.

The electrical path may be a discharge path, or a static discharge path.

According to a third aspect of the present invention there is provided a mass measurement apparatus comprising the weighing device according to the second aspect of the present invention.

The third aspect of the present invention may have any of the features of the first or second aspects of the present invention, unless incompatible with the features of the third aspect of the present invention.

The apparatus may be configured to calculate a mass of the object based on at least a measurement output of the weighing device.

According to a fourth aspect of the present invention there is provided a support for a weighing device, the support comprising first and second parts, wherein the first and second parts are electrically connected by an electrically resistive component.

The electrically resistive component may have an electrical resistance greater than or equal to 100 kΩ and less than or equal to 10 MΩ.

The electrically resistive component may have an electrical resistance greater than or equal to 500 kΩ and less than or equal to 2 MΩ.

The fourth aspect of the present invention may have any of the features of the first, second or third aspects of the present invention, unless incompatible with the fourth aspect of the present invention.

The present invention includes the combination of the aspects and preferred features described except where such a combination is clearly impermissible or expressly avoided.

### BRIEF DESCRIPTION OF THE DRAWINGS

Embodiments of the present invention will now be discussed, by way of example only, with reference to the accompanying Figures, in which:

FIG. 1 is a schematic illustration of a weighing pan previously used by the inventors;

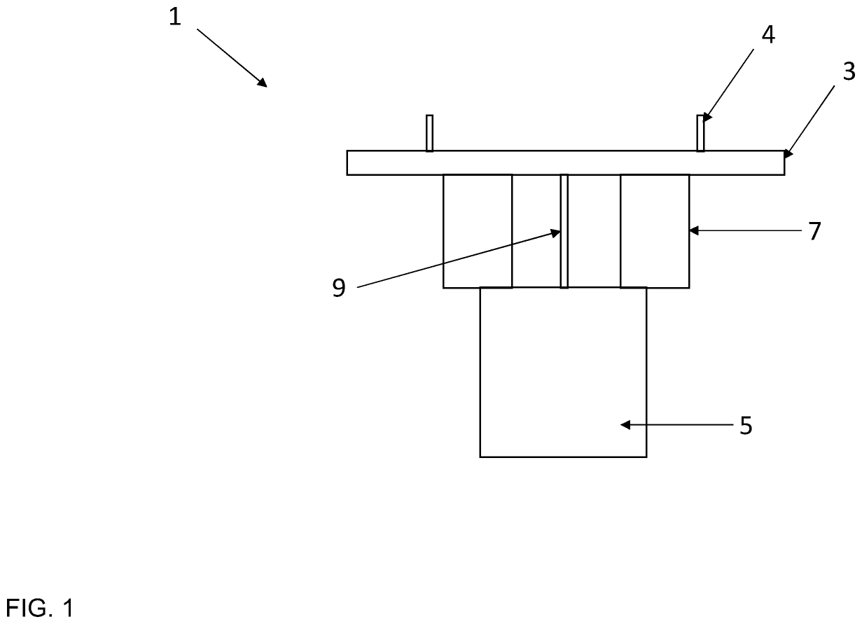

FIG. 2 is a schematic illustration of a weighing pan according to a first embodiment of the present invention;

FIG. 3 is a schematic illustration of a top view of the weighing pan according to the first embodiment of the present invention;

FIG. 4 is a schematic illustration of a weighing pan according to a second embodiment of the present invention; and

FIG. 5 is a schematic illustration of a weighing device according to a third embodiment of the present invention.

### DETAILED DESCRIPTION OF THE PREFERRED EMBODIMENTS AND FURTHER OPTIONAL FEATURES OF THE INVENTION

Aspects and embodiments of the present invention will now be discussed with reference to the accompanying figures. Further aspects and embodiments will be apparent to those skilled in the art. All documents mentioned in this text are incorporated herein by reference.

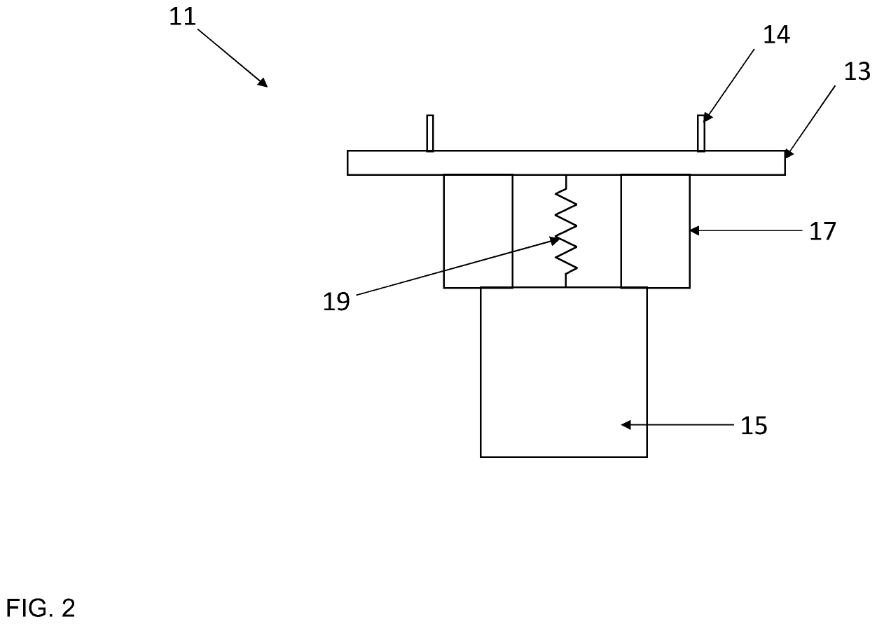

FIG. 2 is a schematic illustration of a weighing pan 11 (a support) according to a first embodiment of the present invention.

As shown in FIG. 2, the weighing pan 11 comprises a pan part 13 (a support part) for supporting a wafer during a weight measurement.

The weighing pan 11 may be referred to as a weighing pan assembly, for example.

The weighing pan 11 may be referred to as a balance pan.

The pan part 13 is configured to contact an underside of the wafer to support the wafer.

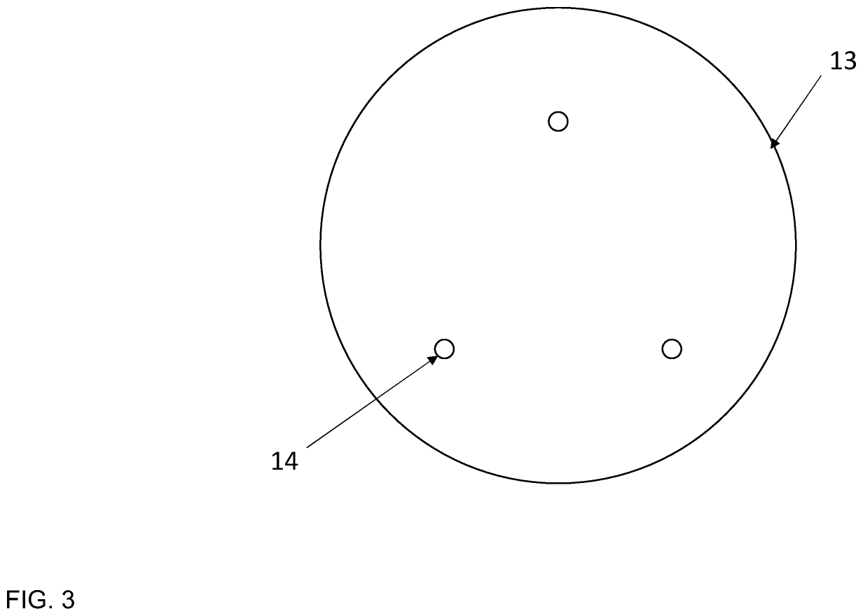

As shown in FIGS. 2 and 3, the pan part 13 comprises a plurality of pins 14 that protrude from a top surface of the pan part 13 perpendicular to a main plane of the pan part 13. The pins 14 are configured to contact an underside of the wafer so as to support the wafer. In this embodiment, there are three of the pins 14. In general, there may be three or more of the pins 14.

As shown in FIG. 3, in this embodiment the three pins 14 are arranged in a triangular arrangement around a centre of the pan part 13 (when the pan part 13 is viewed from above as in FIG. 3). For example, the three pins 14 may be arranged in an equilateral triangle which may be centred on the centre of the pan part 13 (when the pan part 13 is viewed from above as in FIG. 3).

The pan part 13 (including the pins 14) is electrically conductive.

In particular, the pan part 13 (including the pins 14) is made of, or mainly made of, one or more electrically conductive materials.

For example, the pan part 13 (including the pins 14) may be made of, or mainly made of, one or more metals.

For example, the pan part 13 (including the pins 14) may be made of, or mainly made of, aluminium or stainless steel. Aluminium may be preferably due to its low weight.

For example, a main body of the pan part 13 may be made of aluminium and the pins 14 may be made of stainless steel (due to its durability and lower thermal conductivity).

Therefore, when a charged wafer is positioned on the weighing pan 11, electric charge can be discharged from the wafer to the pan part 13.

A coating may be applied to at least part of the pins 14, for example to distal ends of the pins 14 that are arranged to contact the wafer, for example to improve the durability of the pins 14. For example, a titanium nitride coating may be applied to at least the distal ends of the pins 14.

The weighing pan 11 further comprises a leg 15 (a mounting part) that extends perpendicularly to the pan part 13. The leg 15 is configured to be received by a weighing device so as to mount the weighing pan 11 on the weighing device.

More specifically, the leg 15 may be configured to be received by a load cell of the weighing device, or by a housing of the load cell, so as to mount the weighing pan 11 on the load cell.

The leg 15 may alternatively be referred to as a mounting part for mounting the weighing pan 11 on the weighing device or load cell.

The leg 15 is electrically conductive. In particular, the leg 15 is made of, or mainly made of, one or more electrically conductive materials. For example, the leg 15 may be made, or mainly made of, of one of more metals.

In this embodiment, the leg 15 is made of, or mainly made of, aluminium or stainless steel. Aluminium may be preferable due to its low weight.

The leg 15 is in the form of a longitudinal pin or shaft that is located on a longitudinal axis of the weighing pan 11 and extends along the longitudinal axis.

The weighing pan 11 further comprises an electrical and thermal insulator part 17 between the pan part 13 and the leg 15. The pan part 13 and the leg 15 are physically separated by the electrical and thermal insulator part 17. Furthermore, the pan part 13 and the leg 15 are electrically and thermally insulated from each other by the electrical and thermal insulator part 17.

In this embodiment the electrical and thermal insulator part 17 is made of a ceramic and/or a plastic. However, other insulating materials can be used instead or in addition.

The electrical and thermal insulator part 17 prevents heat from a wafer on the weighing pan 11 from being conducted to the load cell through the weighing pan 11, where it may cause an error in the output of the load cell.

However, as mentioned above, electrical charges trapped on a wafer on the weighing pan 11 can also cause inaccurate measurements by the load cell, due to electrostatic forces between the wafer and the surroundings.

Therefore, to enable controlled discharge of electrical charge on the wafer, the weighing pan 11 further comprises a component 19 having a predetermined electrical resistance that electrically connects the pan part 13 to the leg 15.

In particular, in this embodiment the component 19 is an electrical resistor or an electrical resistor wire or a resistive film or a resistive structure, for example.

The component 19 may have an electrical resistance greater than or equal to 100 kΩ and less than or equal to 10 MΩ, for example.

The component 19 may have an electrical resistance greater than or equal to 500 kΩ, for example.

The component 19 may have an electrical resistance less than or equal to 5 MΩ, or 2 MΩ, or 1.5 MΩ for example.

The component 19 may be located inside the electrical and thermal insulator part 17, or may be arranged outside of the electrical and thermal insulator part 17.

The component 19 allows discharge of electric charge from the wafer through the weighing pan 11 to the load cell. However, the resistance of the component 19 prevents or reduces the likelihood of a sharp spike of discharging electric charge to the load cell from the weighing pan 11.

The discharging of electric charge from the wafer to the load cell through the weighing pan 11 is therefore controlled by the resistance of the component 19.

The weighing pan 11 provides a single electrical path from a wafer loaded on the pan part 13 to a weighing device on which the weighing pan 11 is mounted by the leg 15, wherein the single electrical path is via or through the component 19.

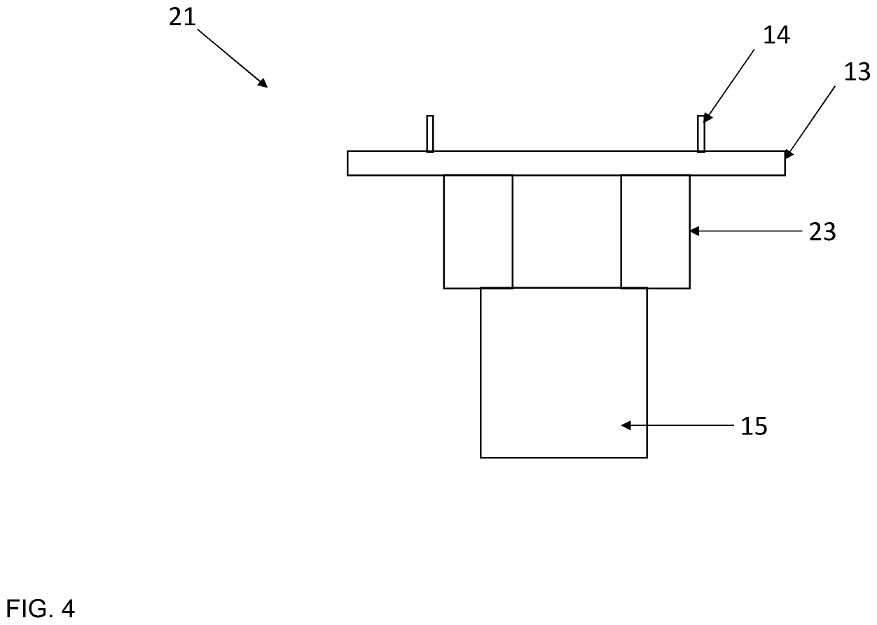

A weighing pan 21 according to a second embodiment of the present invention is illustrated in FIG. 4.

Features that are the same as corresponding features in FIG. 2 are indicated using the same reference signs, and description thereof is omitted for conciseness.

The weighing pan 21 according to the second embodiment may have any of the features of the weighing pan 11 according to the first embodiment, unless incompatible with the features of the second embodiment.

The weighing pan 21 according to the second embodiment differs from the weighing pan 11 according to the first embodiment in that the electrical and thermal insulator part 17 in the first embodiment is replaced with a component 23 having a predetermined electrical resistance that electrically connects the pan part 13 to the leg 15.

The predetermined electrical resistance of the component 23 may be the same as the predetermined electrical resistance of the component 19 discussed above.

The component 23 is positioned or located between the pan part 13 and the leg 15 and physically separates the pan part 13 from the leg 15.

The component 23 may be thermally insulating.

The component 23 allows discharge of electrical charge from the wafer through the weighing pan 21 to the load cell. However, the resistance of the component 23 prevents or reduces the likelihood of a sharp spike of discharging electric charge to the load cell from the weighing pan 21.

The discharging of electric charge from the wafer to the load cell through the weighing pan 21 is therefore controlled by the resistance of the component 23.

The component 23 may be in the form of a washer or plate or film.

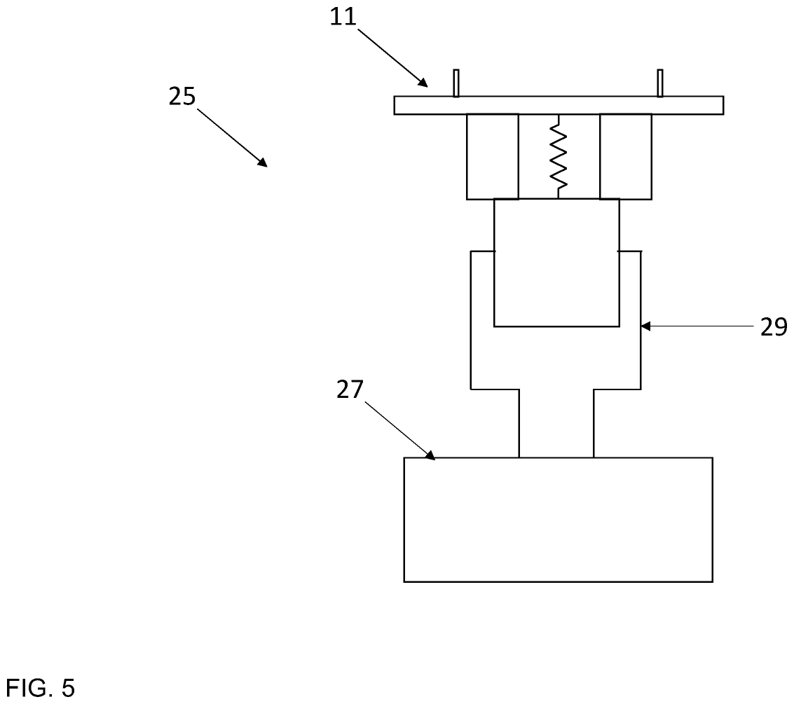

FIG. 5 is a schematic illustration of a weighing device 25 according to a third embodiment of the present invention.

The weighing device 25 includes the weighing pan 11 of the first embodiment. The weighing pan 11 may have any of the features of the first embodiment discussed above. Alternatively, the weighing pan 11 can be replaced with the weighing pan 21 according to the second embodiment of the present invention.

The weighing pan 11 is mounted on a load cell 27 of the weighing device 25.

The load cell 27 is grounded (electrically connected to ground).

The load cell 27 is a force transducer that converts a weight force applied to the load cell 27 into an electrical signal that corresponds to the weight force.

For example, the load cell 27, or a housing of the load cell 27, may comprise a receiving portion 29 that is configured to receive the leg 15 of the weighing pan 11, so as to mount the weighing pan 11 on the load cell 27.

Therefore, when the weighing pan 11 is mounted on the load cell 27 and an object such as a wafer is loaded on the weighing pan 11, the load cell 27 will generate a measurement output corresponding to the weight of the object.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A support for a weighing device, the support comprising:
a support part for supporting an object during a weight measurement; and
a mounting part for mounting the support on a weighing device;
wherein the support part and the mounting part are electrically connected by a component having an electrical resistance greater than or equal to 100 kΩ and less than or equal to 10 MΩ.

2. The support according to claim 1, wherein the component has an electrical resistance greater than or equal to 500 kΩ.

3. The support according to claim 1, wherein the component has an electrical resistance less than or equal to 5 MΩ.

4. The support according to claim 1, wherein the component comprises a resistor or a resistor wire or a resistive film or a resistive structure.

5. The support according to claim 1, wherein the support further comprises an electrical insulator part between the support part and the mounting part.

6. The support according to claim 5, wherein the electrical insulator part is also a thermal insulator.

7. The support according to claim 5, wherein the electrical insulator part comprises a ceramic and/or a plastic.

8. The support according to claim 1, wherein the support part is electrically conductive.

9. The support according to claim 1, wherein the support part is made of, or mainly made of, one or more electrically conductive materials.

10. The support according to claim 1, wherein the support part is made of, or mainly made of, one or more metals.

11. The support according to claim 1, wherein the mounting part is electrically conductive.

12. The support according to claim 1, wherein the mounting part is made of, or mainly made of, one or more electrically conductive materials.

13. The support according to claim 1, wherein the mounting part is made of, or mainly made of, one or more metals.

14. The support according to claim 1, wherein the support part comprises a plurality of contact elements that are configured to support the object during the weight measurement.

15. The support according to claim 14, wherein at least part of one or more of the contact elements is coated.

16. The support according to claim 14, wherein the contact elements are electrically conductive.

17. The support according to claim 14, wherein the contact elements are made of, or mainly made of, one or more electrically conductive materials.

18. The support according to claim 14, wherein the contact elements are made of, or mainly made of, one or more metals.

19. A weighing device having the support according to claim 1.

20. The weighing device according to claim 19, wherein the weighing device further comprises a load cell.
